(19) United States
(12) Patent Application Publication
(10) Pub. No.: US 2003/0168605 A1
(43) Pub. Date: Sep. 11, 2003

(54) Radiation detector with semiconductor junction for measuring high rates of x radiation or gamma radiation dose

(76) Inventors: Pascal Chambaud, Igny (FR); Mikael Kais, Rusil Malmaison (FR)

Correspondence Address: Thelen Reid & Priest, PO Box 640640, San Jose, CA, 95164-0640, US

(21) Appl. No.: 10/239,376

(22) PCT Filed: Mar. 20, 2001
(86) PCT No.: PCT/FR01/00826

(30) Foreign Application Priority Data
Mar. 21, 2000 (FR) 00/03594

(51) Int. Cl. G01T 1/24

(52) U.S. Cl. 250/370.15

(57) ABSTRACT

This invention relates to a radiation detector comprising at least one semiconducting junction capable of generating electron-hole pairs under the action of the detected radiation and connected in photovoltaic cell mode. The detector comprises means (8, 9, 10, 11, 12) for placing and maintaining the junction at an approximately constant temperature (TA).

The invention is particularly applicable in the field of measuring gamma or X radiation dose rates that can reach high values.

### TECHNICAL DOMAIN AND PRIOR ART

The invention relates to a radiation detector with a semiconducting junction for measuring high dose rate of X or γ radiation.

More particularly, the invention relates to a radiation detector with semiconducting junction capable of measuring high radiation dose rates (for example 50 kGy) and operating at very high accumulated doses.

The invention is advantageously applied in hot cells in the nuclear industry.

The technologies used in the field of measuring high rate gamma radiation dose rates must be sufficiently robust to enable optimum operation for as long as possible. The high doses applied to the exposed detector materials are frequently reached quickly and the performances of the detectors are correspondingly degraded.

One known detector is the ionisation chamber. An ionisation chamber requires the presence of a voltage of several hundred volts in order to create the electric field required to collect particles (electrons and holes) created by the ionisation phenomenon created by the photon rate. The current thus created is measured by a preamplifier stage making a current/voltage conversion. The high dose rates enable the use of small chambers, for example of the order of a few cm³. In order to cover a rate measurement range from 10 Gy/h to 10 kGy/h, it is for example necessary to use a first chamber with a detection volume of 0.125 cm³ to cover a range varying from 10 Gy/h to 1 kGy/h and a second 1 cm³ chamber to cover a range from a few 100 Gy/h to 5 kHy/h or more.

This type of detector has many disadvantages. It requires the presence of a high polarisation voltage and only outputs a very weak signal (in the picoamperes range).

This signal weakness makes it necessary to use high performance cables (frequently based on mineral insulation and mechanically very delicate to manipulate) and high performance preamplifiers. Its various constituents thus make an expensive technology necessary.

Another technology based on semiconductors is also used to make radiation detectors. The semiconductors technology has may advantages: no high voltage, very low volume, a stronger signal (within the nanoamperes range), with the resulting consequences for the cable and the preamplifier. This means that a very wide variety of devices can be made at low cost.

A radiation detector made using a semiconductor technology also implements the ionisation phenomenon. An ionisation phenomenon then occurs inside the material and no longer in a gas as for the ionisation chamber.

Electron-hole pairs are created with an intensity proportional to the rate of detected particles. When particles penetrate into the material they transfer their energy into it. The electron-hole pairs thus created are separated under the action of an electric field applied to the semiconducting material by metallic electrodes. The electrons migrate to an electrode at a positive potential and the holes migrate to an electrode at a negative potential. Electrical closure of the circuit enables circulation of a current.

The energy necessary to produce an electron-hole pair depends on the prohibited band of the semiconductor which is about 3.6 eV for silicon, while the ionisation energy is of the order of 30 eV in a gas. The number of free charges created per detected photon is greater in a semiconducting material than in a gas. The atomic number and the high density of the semiconducting materials are thus a means of designing semiconductor detectors with a volume very much less than the volume of gas detectors.

Consider the case of a radiation detector with semiconductor composed of a semiconducting junction. If a sufficiently high inverse polarisation voltage is applied, an electric field is created which causes the separation of charges. The polarisation voltage also causes a leakage current which increases with temperature and with aging of the semiconducting material under the effect of the accumulated radiation dose. If high doses are to be considered (for example above 100 kGy), the leakage current may quickly exceed the useful signal. However, the signal to noise ratio is very severely modified well before the performances are degraded to this extent. Therefore, it may be considered that a reduction in the leakage current, or the limitation of its effects, forms an essential stake for any electronics operating under radiation.

The leakage current increases when the detector temperature increases. According to known art, the leakage current is reduced by cooling the detector to very low temperatures, which makes the detection system more complex.

One solution for eliminating these problems consists of using the semiconducting junction in photovoltaic cell mode. Photovoltaic cell mode means the use of the junction closed on a resistance with a very low value or closed on an electronic circuit capable of keeping an almost zero potential difference between the terminals of the junction. No external polarisation voltage is then applied to the semiconducting junction. The voltage that appears at the terminals of the junction is the result of creation of electron-hole pairs under the effect of incident photons. The effects related to the leakage current are then extremely small.

The most general case of a detector in photovoltaic cell mode is shown in FIG. 1. FIG. 1 shows an equivalent scheme 5 of the junction closed by a very low load resistance 4.

The equivalent scheme 5 of the junction in photovoltaic cell mode comprises a generator 1 of a photocurrent Iph, an internal resistance 2, and a theoretical junction 3 carrying a direct current If. The resistive load 4 collects a current I such that:

I=Iph−If.

A voltage V proportional to the current I is then created at the terminals of the resistive load 4. The voltage V imposes a direct polarisation Vf at the junction 3 which creates the direct current If in the direction opposed to the direction of the photocurrent Iph.

If firstly the resistive load is very low and also the internal resistance 2 can be neglected, the measured short circuit current may be equal to Iph. This particular case is shown in FIG. 2, in which the very low value of the resistive load may be composed of an ammeter for very low currents, so that the current Iph can be measured. The resistive load may also be replaced by an electronic circuit with a low input impedance, or capable of maintaining an almost zero voltage between its terminals.

A circuit using the photovoltaic cell mode in FIG. 2 is described in patent U.S. Pat. No. 4,243,885. A detector with a semiconducting diode made of CdTe material is used as a low radiation dose rates detector. In this document, the resistive load is composed of an amplifier circuit with a very low input impedance.

The measurements made do not exceed a few tens of mGy/h. The detector usage temperature is of the order of magnitude of the usual ambient temperature (20° C.). A temperature characterization of the detector is described for a temperature variation of between −20° C. and +60° C. A dependence of the current response of the detector as a function of the temperature is evaluated at less than 0.25% per degree Celsius.

Despite the extent of the temperature range used to evaluate this coefficient precisely, the divulged device is always effectively used at ambient temperature. Thus, temperature fluctuations influencing the device are only a few degrees and it is then possible to neglect the influence of the temperature on the detector signal.

An article entitled “A Simplified Instrument for Solid-State High-Gamma Dosimetry” by R. Tanaka and S. Tajima (International Journal of Applied Radiation and Isotopes, 1976, vol. 27, pp 73-77) divulges the characterization results of solar cells under gamma radiation. This document presents a non-polarized PN junction used as a high dose rate gamma radiation detector. The influence of the temperature on the detector response is studied. The dependence of the current response of the detector as a function of the temperature is evaluated at 0.3% per degree Celsius.

As in the previous case, a wide range of thermal variations is used to characterize the detector. But practical use takes place at ambient temperature, which only varies by a few degrees.

Conversely, the device according to the invention must be able to operate at any temperature between +10 and +80° C. When the temperature varies within this range, the output signal due to the junction alone varies by a very high factor (typically equal to 21%). A variation of this magnitude is too high to be acceptable.

The detected signal varies almost linearly depending on the temperature. Furthermore, the signal variation as a function of the temperature varies non-linearly as a function of the dose rate. It is then difficult to make a temperature compensation for the signal drift. This type of compensation implies calibration of the detector. The compensation operation is then complex and expensive.

The invention does not have these disadvantages.

Presentation of the Invention

The invention relates to a radiation detector comprising at least one semiconducting junction capable of generating electron-hole pairs under the action of the detected radiation and connected in photovoltaic cell mode. The detector also comprises means for placing and maintaining the semiconducting junction at an approximately constant temperature.

A connection in photovoltaic cell mode means not only the case in which the junction is closed on a pure resistance with a very low value but also the case in which the junction is closed on an electronic circuit capable of maintaining an almost zero potential difference between its terminals.

The invention also relates to a process for increasing the detection sensitivity of at least one semiconducting junction generating electron-hole pairs under the action of a radiation. The process comprises a junction heating step.

According to the preferred embodiment of the invention, the approximately constant temperature at which the junction is maintained is greater than or equal to the ambient temperature of the medium surrounding the junction in its working position. It is possible that the working position of the component is in a rack or an electronic box in which an ambient temperature is greater than the temperature of the room in which the rack or the box is located.

Preferably, the constant temperature higher than the ambient temperature of the junction is the highest temperature that this junction can resist without degradation adversely affecting the envisaged application.

According to one advantageous improvement of the invention, several semiconducting junctions may be put in parallel. The diodes firstly have their anodes connected to each other, and secondly their cathodes are connected to each other. The total measured current is then the sum of the currents detected by each junction.

It has been observed that the fact of putting the junction(s) at a higher temperature than the ambient temperature increases the sensitivity of the detector.

Apart from the fact of increasing the sensitivity of the detector, the means that put and hold the junction(s) at a constant temperature higher than the ambient temperature are used to stabilize the signal with regard to variations of the ambient temperature. These means advantageously reduce the detection volume compared with the detection volume of a detector according to prior art, for equivalent sensitivity.

These means comprise means of heating the junction(s), means of measuring the temperature of the junction(s), and possibly thermal insulation means with regard to the environment.

Furthermore, they comprise regulation means that may be remote, that switch heating means on when the temperature of the junction(s) drops below the constant design temperature for operation.

### BRIEF DESCRIPTION OF THE FIGURES

Other characteristics and advantages of the invention will become clear after reading a preferred embodiment of the invention with reference to the attached figures among which:

FIG. 1 shows a detector in photovoltaic cell mode according to known art,

FIG. 2 shows a special case of a detector in photovoltaic cell mode as shown in FIG. 1,

FIG. 3 shows an electrical scheme of a radiation detector according to the preferred embodiment of the invention,

FIG. 4 shows a sectional top view of an example embodiment of a radiation detector according to the preferred embodiment of the invention,

FIG. 5 shows a transverse sectional view of an example embodiment of the radiation detector in FIG. 4.

### DETAILED DESCRIPTION OF EMBODIMENTS OF THE INVENTION

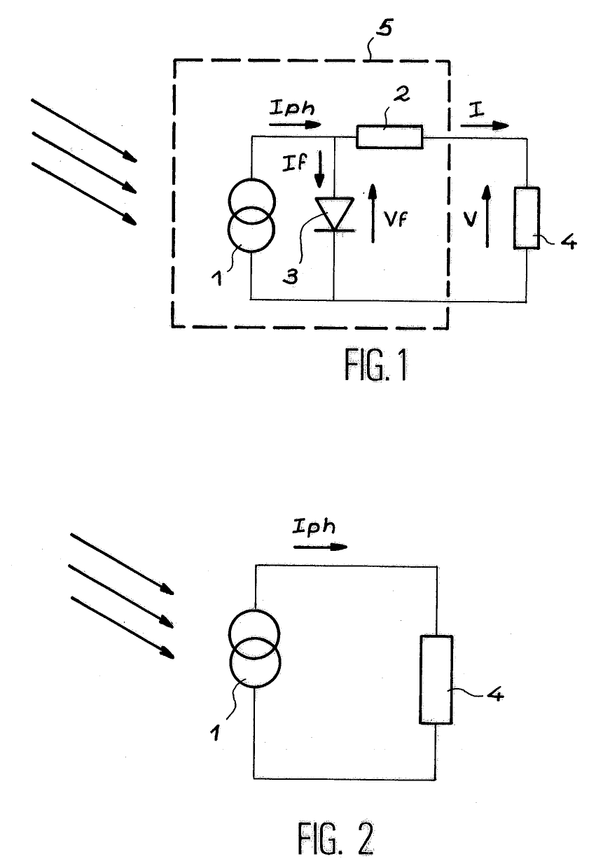

FIGS. 1 and 2 were described above, and therefore there is no point in describing them again.

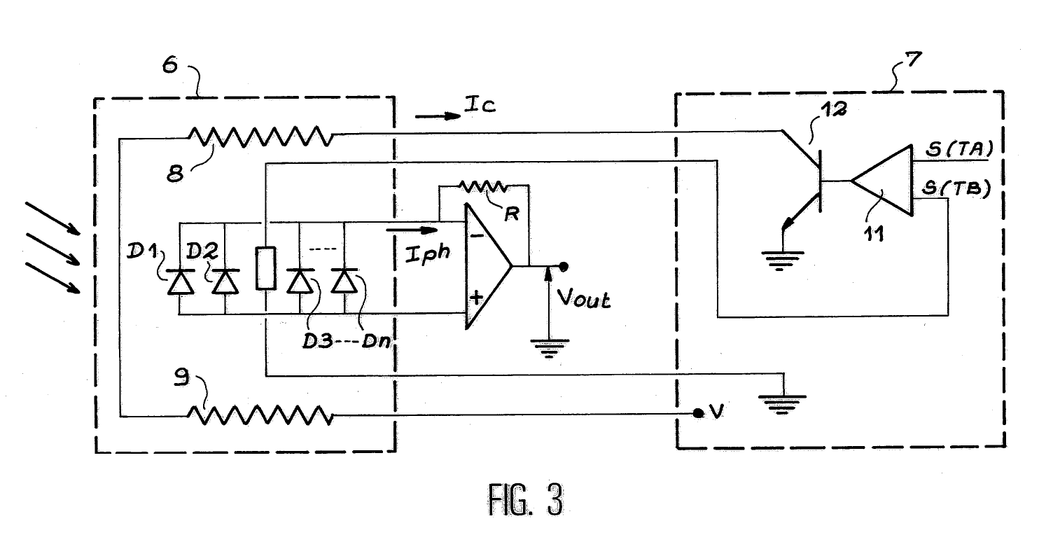

FIG. 3 shows an electrical diagram for the radiation detector according to the preferred embodiment of the invention.

The radiation detector comprises a semiconducting part 6 and electronic heating regulation means 7.

The semiconducting part 6 comprises n semiconducting junctions in parallel D1, D2, D3, . . . , Dn. The semiconducting junctions are preferably PN junctions. They are closed by an electronic circuit that maintains an almost zero voltage at its terminals, which are the inputs of an operational amplifier. This circuit, given as a non-limitative example, has a very high input impedance under static conditions. However, its operation under dynamic conditions maintains an almost zero potential difference at its terminals, so that it can perform the same role as a resistance with a very low value. This amplifier has a counter-reaction resistance R, preferably with a high value, to obtain a high gain. The amplifier output outputs the detector output signal Vₒᵤₜ, equal to

Vₒᵤₜ=R.Iph

Two heating resistances in series 8 and 9 are placed close the junctions D1, . . . , Dn. Heating is achieved by circulating a current Ic in resistances 8 and 9.

A thermistor 10 placed close to the junctions D1, . . . , Dn measures the temperature of the junctions. The thermistor 10 supplies a measurement of the temperature of the junctions, to control operation of the regulation means.

The electronic heating regulation means 7 comprise means of cutting off the power supply to resistances 8 and 9 when the temperature TB measured by the thermistor 10 is greater than a set temperature TA. The set temperature TA is greater than or equal to the ambient temperature of the medium surrounding the semiconducting junction. As a non-limitative example, the semiconducting part 6 may be held at a temperature of 80° Celsius for an ambient temperature of 70° Celsius.

According to the embodiment illustrated in FIG. 3, the electronic regulation means operate in On/Off mode. However, any other type of regulation may be used without going outside the framework of the invention. For example, it may be a Proportional/Integral/Derivative (PID) type regulation.

According to the example illustrated in FIG. 3, the regulation circuit in On/Off mode comprises a comparator 11, a first input of which receives a signal S(TA) representing the set temperature TA and a second input receives a signal S(TB) representing the temperature TB measured by the thermistor 10. The output from the comparator 11 controls a transistor 12 to output the current Ic passing through resistances 8 and 9.

For example, transistor 12 is a two-pole transistor in which the collector is connected to a first terminal of the assembly composed of the resistances 8 and 9 in series and the emitter of which is connected to the ground of the regulation device 7. The second terminal of the assembly formed by the resistances 8 and 9 in series is connected to a power supply voltage V. The two heating resistances 8 and 9 carry the current Ic when the temperature TB is less than the set temperature TA. The power supply to resistances 8 and 9 is cut off when the temperature measured by the thermistor is greater than the set temperature.

Elements 11 and 12 that form the electronic control means 7 are composed of transistors in two pole technology or JFET technology. For example, it is then possible to achieve temperature regulation with a precision of ±0.5% for an accumulated dose greater than 100 kGy.

Due to the almost zero polarisation voltage at the terminals of junctions D1, D2, . . . , Dn, the leakage current remains negligible compared with the photocurrent Iph that passes through the junctions.

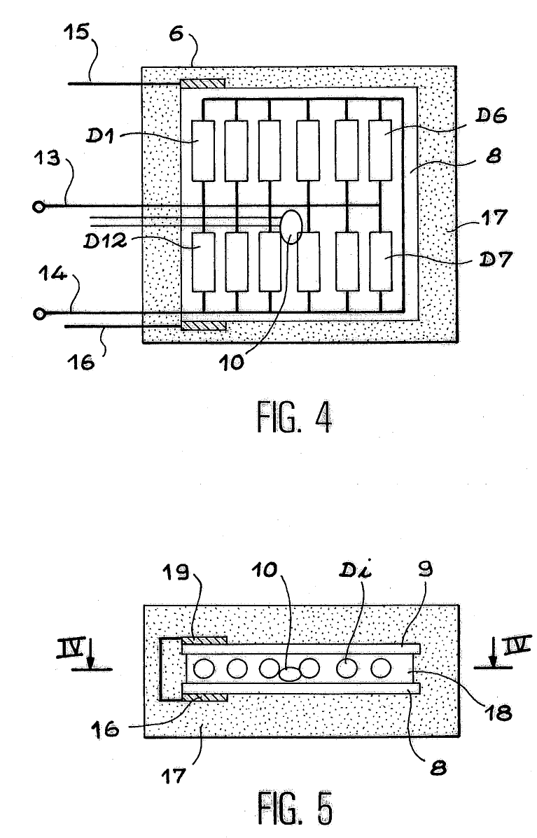

FIG. 4 shows a top view of a section for an example embodiment of the radiation detector according to the preferred embodiment of the invention. The section according to FIG. 4 is a section along axis IV-IV in FIG. 5.

All that is shown in FIG. 4 is the semiconducting part 6 of the detector according to the invention. As a non-limitative example, the radiation detector comprises 12 diodes (n=12).

Each PN junction is a rectifying diode comprising an anode and a cathode. The anodes of diodes D1, . . . , D12 are all connected to the same electrical terminal 13, and the cathodes of diodes D1, . . . , D12 are all connected to the same electrical terminal 14.

Diodes D1, . . . , D12 are located in the same plane, at the surface of a first resistance, for example resistance 8 in FIG. 4.

Diodes D1, . . . , D12 are arranged on each side of an electrically conducting line connected to the electrical terminal 13 and electrically insulated from the resistance 8. Thus, six first diodes D1, . . . , D6 are located on a first side of the conducting line and six other diodes are located on a second side of the conducting line.

Electrical connections 15 and 16 are connected to the resistance 8 and form a common electrical terminal for the resistance 8. The thermistor 10 is located close to the diodes D1, . . . , D12 to provide the temperature measurement S(TB) mentioned above. The resistance 8 is placed on a thermally insulating material 17, for example a polyurethane foam type insulation.

FIG. 5 represents a cross-sectional view of the example embodiment of the radiation detector in FIG. 4.

Diodes Di (i=1, 2, . . . , 12) are sandwiched between the two plane resistances 8 and 9. The diodes are surrounded by a heat conducting paste 18 to make the detector temperature uniform. The thermistor 10 is embedded in the heat conducting paste 18. A first electrical connection, for example connection 16, forms a terminal of the resistance 8. A second electrical connection 19 forms a terminal of resistance 9. The electrical connections 16 and 19 are connected to each other to put the resistances 8 and 9 in series.

According to the embodiment in FIG. 5, the electrical connection between connections 16 and 19 is made inside the insulating material 17. The invention also relates to the case in which the electrical connection is made outside the insulating material.

Diodes Di (i=1, 2, . . . , 12), resistances 8 and 9 and thermistor 10 are surrounded by the insulating material 17. The insulating material 17 advantageously contributes to reducing the power necessary for heating the detector, particularly if the ambient temperature is relatively low, for example of the order of 10° Celsius or less than 10° Celsius. The thermal insulation provided by the material 17 also minimizes the increase in the temperature of electronic regulation means 7 located close to the semiconducting part 6.

1. X or γ radiation detector to measure high dose rates, capable of operating under high irradiation to obtain accumulated dose rates greater than or equal to 100 kGy, comprising at least one semiconducting junction (D1, D2, . . . , Dn) capable of generating electron-hole pairs under the action of the detected radiation and connected in photovoltaic cell mode, characterised in that it comprises means for placing and maintaining the semiconducting junction to an approximately constant temperature (TA) greater than ambient temperature.

2. Radiation detector according to claim 1, characterised in that the means for placing and maintaining the semiconducting junction (D1, D2, . . . , Dn) at an approximately constant temperature (TA) comprise measurement means (10) to measure the temperature of the junction (D1, D2, . . . , Dn), junction heating means (8, 9) and junction temperature regulation means (7) to switch the heating means (8, 9) on or off as a function of measured temperature.

3. Radiation detector according to claim 2, characterised in that the heating means comprise at least one resistance (8, 9).

4. Radiation detector according to claim 2 or 3, characterised in that the junction temperature measurement means (10) comprise a thermistor (10).

5. Radiation detector according to any one of claims 2 to 4, characterised in that the regulation means (7) operate in On/Off mode.

6. Radiation detector according to any one of claims 2 to 4, characterised in that the regulation means (7) operate in proportional/integral/derivative mode.

7. Radiation detector according to any one of the previous claims, characterised in that it comprises at least two semiconducting junctions in parallel.

8. Radiation detector according to any one of the previous claims, characterised in that the semiconducting junction is a PN junction.

9. Radiation detector according to any one of claims 2 to 8, characterised in that the junction, the heating means (8, 9) and the measurement means (10) of the junction temperature are thermally insulated from the ambient temperature.

10. Radiation detector according to any one of the previous claims, characterised in that the semiconducting junction is closed on a pure resistance with a very low value.

11. Radiation detector according to any one of claims 1 to 9, characterised in that the semiconducting junction is closed on an electronic circuit capable of maintaining an almost zero potential difference between its terminals.

12. Radiation detector according to any one of claims 4 to 11, characterised in that it comprises two plane resistances (8, 9) installed in series, and in that the semiconducting junction is sandwiched between the two plane resistances (8, 9) and surrounded by a heat conducting paste (18) located between the two plane resistances (8, 9), the thermistor (10) being embedded in the heat conducting paste (18).

13. Radiation detector according to claim 12, characterised in that the assembly consisting of the two plane resistances (8, 9), the junction, the thermistor (10) and the semiconducting paste is surrounded by an insulating material (17).

14. Hot cell used in the nuclear industry, characterised in that it comprises a radiation detector according to any one of claims 1 to 13.

15. Process to increase the detection sensitivity of an X or γ radiation detector to measure high dose rates, capable of operating under high irradiation to obtain accumulated dose rates greater than or equal to 100 kGY, the detector comprising at least one semiconducting junction (D1, D2, . . . , Dn) capable of generating electron-hole pairs under the action of detected radiation and connected in photovoltaic cell mode, characterised in that it comprises heating of the semiconducting junction.
